(19) United States
(12) Patent Application Publication
(10) Pub. No.: US 2026/0126747 A1
(43) Pub. Date: May 7, 2026

(54) MANAGEMENT DEVICE, MANAGEMENT SYSTEM, MANAGEMENT METHOD, AND MANAGEMENT PROGRAM PRODUCT

(71) Applicant: KONICA MINOLTA, INC., Tokyo (JP)

(72) Inventors: Ken Miyazaki, Sagamihara-shi (JP); Masatsugu Kouguchi, Tokyo (JP); Tomohiro Mikami, Tokyo (JP)

(73) Assignee: KONICA MINOLTA, INC., Tokyo (JP)

(21) Appl. No.: 19/382,227

(22) Filed: Nov. 6, 2025

(30) Foreign Application Priority Data
Nov. 7, 2024 (JP) 2024-195187

(51) Int. Cl. G03G 15/00; G06F 3/12

(52) U.S. Cl. CPC G03G 15/556; G03G 15/5016; G03G 15/5062; G03G 15/5075; G06F 3/1208; G06F 3/1229

(57) ABSTRACT

A management device includes an interface and a hardware processor. The interface is configured to connect with an image forming apparatus that forms a document image and a non-document image on a medium. The hardware processor is configured to acquire a print coverage of the non-document image from the image forming apparatus, acquire temperature and humidity information of the image forming apparatus, acquire a color material adhesion proportion that is a function of the temperature and humidity information, and calculate information on color material consumption by multiplying a color material adhesion amount by the color material adhesion proportion. The color material adhesion amount is derived from a print coverage of the document image and the print coverage of the non-document image.

### CROSS-REFERENCE STATEMENT

The present application is based on, and claims priority from, Japanese Patent Application Number 2024-195187, filed November 7, 2024, the disclosure of which is hereby incorporated by reference herein in its entirety.

### BACKGROUND OF THE INVENTION

### Technical Field

The present invention relates to a management device, a management system, a management method, and a management program product, and, for example, may relate to a management device that manages an image forming apparatus that performs color printing on a transparent medium.

### Description of Related At

Printing apparatuses of an inkjet type and a toner transfer type are known. With an inkjet type, printing is performed by discharging ink onto a medium by heat or pressure. With a toner transfer type, toner is transferred to a medium and the transferred toner is fixed. With a printing apparatus, it is preferable to estimate an amount of ink consumption in advance so that a user may replenish ink in advance when ink shortage is expected. For example, Patent Literature 1 (Japanese Patent Number 6823962) discloses a device for calculating an amount of ink consumption when printing is performed with an inkjet printing apparatus (paragraphs [0055] and [0062] of Patent Literature 1). This calculation of the ink consumption amount is based on adjustment data.

The technology of Patent Literature 1 (Japanese Patent Number 6823962) calculates the consumption amount of ink based on the adjustment data, but does not take into consideration changes in environment such as temperature and humidity. A printing apparatus that uses dry toner (which is powder) in particular includes a fixing device, and an amount of toner usage fluctuates significantly due to changes in temperature and/or humidity.

### SUMMARY OF THE INVENTION

An object of the disclosure is to provide a management device, a management system, a management method, and a management program product that are capable of more accurately calculating a usage amount of a color material used by an image forming apparatus.

To achieve at least one of the above-mentioned objects, according to an aspect of the disclosure, a management device includes an interface and a hardware processor. The interface is configured to connect with an image forming apparatus that forms a document image and a non-document image on a medium. The hardware processor is configured to acquire, as a print coverage acquiring part, a print coverage of the non-document image from the image forming apparatus, acquire, as a temperature and humidity information acquiring part, temperature and humidity information of the image forming apparatus, acquire, as a color material adhesion proportion information acquiring part, a color material adhesion proportion that is a function of the temperature and humidity information, and calculate, as a color material consumption amount calculating part, information on color material consumption by multiplying a color material adhesion amount by the color material adhesion proportion. The color material adhesion amount is derived from a print coverage of the document image and the print coverage of the non-document image.

### BRIEF DESCRIPTION OF THE DRAWINGS

Advantages and features provided by one or more embodiments of the invention will become more fully understood from the detailed description given hereinbelow and the appended drawings which are given by way of illustration only, and thus are not intended as a definition of the limits of the present invention.

FIG. 1 is a configuration diagram of a management system according to a first embodiment of the present invention.

FIG. 2 is an example of a toner transfer proportion table.

FIG. 3 is a diagram illustrating an example of a display screen displayed when toner consumption estimation is to be started.

FIG. 4 is a flowchart for explaining an operation of a management device according to an embodiment of the present invention.

FIG. 5 is a flowchart for explaining an operation when an image forming apparatus acquires a variation factor.

FIG. 6 is a flowchart for explaining an operation when an image forming apparatus acquires print coverage information of a correction patch.

FIG. 7 is a diagram illustrating a relationship between a toner adhesion amount on a drum and a gradation.

FIG. 8 is a flowchart for explaining an operation when the management device displays a screen of a toner consumption amount.

FIG. 9 is a diagram illustrating an example of a display screen when an estimated toner consumption amount is compared with a toner consumption amount under a worst condition.

FIG. 10 is a diagram illustrating an example of a display screen when an estimated toner consumption amount is compared with a toner consumption amount under the same condition of temperature and humidity.

FIG. 11 is a diagram illustrating an example of a display screen when an estimated toner consumption amount is compared with average values.

FIG. 12 is a diagram illustrating an example of a time-variaton graph display screen that illustrates a variation of a toner consumption amount.

### DETAILED DESCRIPTION

Hereinafter, one or more embodiments of the present invention will be described with reference to the drawings. However, the scope of the invention is not limited to the disclosed embodiments.

In the following description, an embodiment of the present invention will be described in detail with reference to the drawings. It should be noted that the drawings are merely schematic to the extent that the present invention may be fully understood. Therefore, the present invention is not limited to only the examples illustrated in the drawings. In the respective drawings, a common constituent element and similar constituent elements are denoted by the same reference signs, and repeat description thereof is omitted.

A management device includes an interface, a print coverage acquiring part, a temperature and humidity information acquiring part, a color material adhesion proportion information acquiring part, and a color material consumption amount calculating part. The interface is configured to connect to an image forming apparatus that forms a document image and a non-document image (e.g., an image of a correction patch) on a medium. The print coverage acquiring part is configured to acquire a print coverage of the non-document image from the image forming apparatus. The temperature and humidity information acquiring part is configured to acquire temperature and humidity information of the image forming apparatus. The color material adhesion proportion information acquiring part is configured to acquire a color material adhesion proportion (e.g., toner transfer proportion) that is a function of the temperature and humidity information. The color material consumption amount calculating part is configured to calculate information on color material consumption (e.g., toner consumption amount) by multiplying a color material adhesion amount by the color material adhesion proportion. The color material adhesion amount is derived from a print coverage of the document image and the print coverage of the non-document image.

### Embodiment

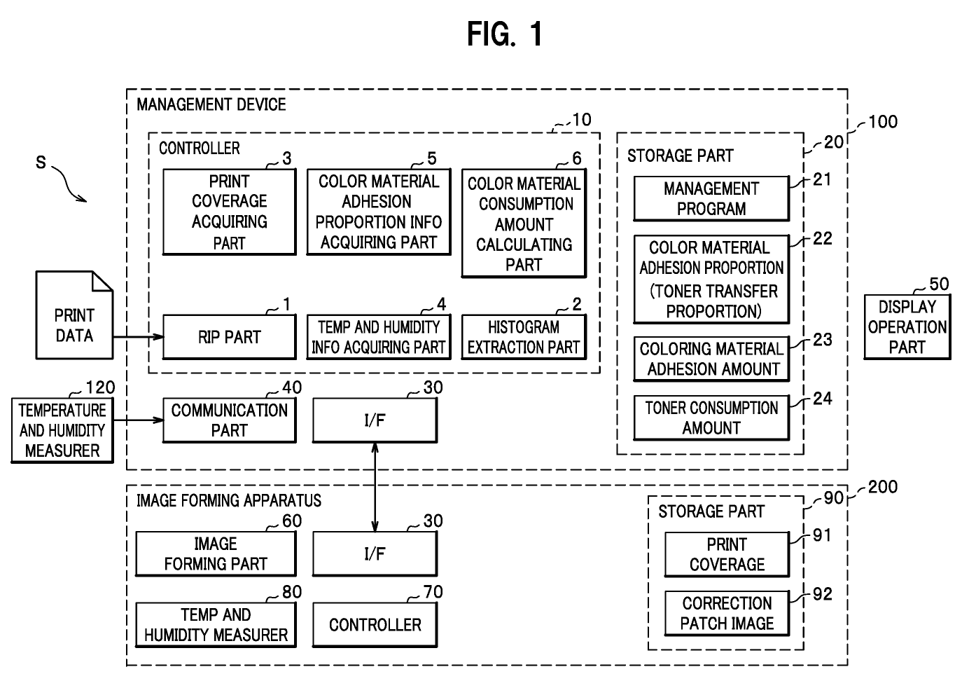

FIG. 1 is a configuration diagram of a management system according to an embodiment of the present invention.

The management system S includes a management device 100, an image forming apparatus 200, and a display operation part 50 as a display. The management system S may further include a temperature and humidity measurer 120 connected via a network (e.g., a local area network [LAN]).

The management device 100 may be configured to include a personal computer (PC) and includes a controller 10, a storage part 20, an interface (I/F) 30, and a communication part 40. The interface 30 is, for example, a universal serial bus (USB) interface that connects to the image forming apparatus 200. The communication part 40 may be connected to the temperature and humidity measurer 120 via a network. The temperature and humidity measurer 120 measures temperature and humidity of an ambient space. In one or more embodiments, the management device 100 may be connected to the image forming apparatus 200 via a network and the communication part 40 instead of the interface 30. In this case, the communication part 40 functions as an interface.

The storage part 20 includes a non-volatile storage part (not illustrated) and a volatile storage part (not illustrated). The non-volatile storage part stores therein a management program 21 and a color material adhesion proportion 22. The volatile storage part stores therein a color material adhesion amount 23 and a toner consumption amount 24. In one or more embodiments, a consumption cost may be stored instead of the toner consumption amount 24.

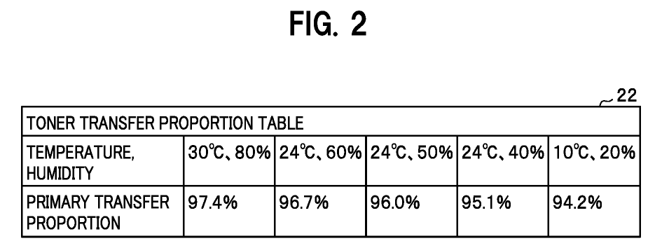

FIG. 2 illustrates an example of a table of a transfer proportion of a toner.

The color material adhesion proportion 22 indicating a transfer proportion of a toner is stored as a table in which a primary transfer proportion is associated with each set of temperature and humidity. Here, the primary transfer proportion refers to a proportion of a toner that transfers from a rotating drum on which the toner is attracted to a medium or an intermediate transfer belt. For example, in the table of the color material adhesion proportion 22, the primary transfer proportion is 97.4% when the temperature and humidity are 30°C and 80%, and the primary transfer proportion is 96.7% when the temperature and humidity are 24°C and 60%. Furthermore, the table indicates that the primary transfer proportion is 96.0% when the temperature and humidity are 24°C and 50%, and the primary transfer proportion is 95.1% when the temperature and humidity are 24°C and 40%. Furthermore, the table indicates that the primary transfer proportion is 94.2% when the temperature and humidity are 10°C and 20%. Note that a secondary transfer proportion refers to a transfer proportion between the intermediate transfer belt and the medium.

Returning to the description of FIG. 1, the controller 10 includes a central processing unit (CPU), and implements the following functions by executing the management program 21. That is, the controller 10 implements the functions of a raster image processor (RIP) part 1, a histogram extraction part 2, a print coverage acquiring part 3, a temperature and humidity information acquiring part 4 (shown as “temp and humidity info acquiring part 4” in FIG. 1), a color material adhesion proportion information acquiring part 5 (shown as “color material adhesion proportion info acquiring part 5” in FIG. 1), and a color material consumption amount calculating part 6.

The RIP part 1 converts vector data of print data (document image data) input through the interface 30 or the communication part 40 into raster data. The histogram extraction part 2 extracts density or the like for each toner color name (yellow Y, magenta M, cyan C, black BK, and white W). The print coverage acquiring part 3 acquires a print coverage of a document image using the extraction result of the histogram extraction part 2. Further, the print coverage acquiring part 3 acquires a print coverage of a non-document image (e.g., a correction patch image 92) from the image forming apparatus 200.

The temperature and humidity information acquiring part 4 uses a temperature and humidity measurer 80 built in the image forming apparatus 200 to acquire information on temperature and humidity (temperature and humidity information) in the apparatus. The temperature and humidity information acquiring part 4 calculates an average set of values obtained by averaging the acquired temperature and humidity information for a set period. For example, the set period may be a period indicating a change in season (of four seasons) or a period indicating a rainy season or a dry season. The color material adhesion proportion information acquiring part 5 acquires a toner transfer proportion (color material adhesion proportion 22) that is a function of temperature and humidity. Here, the non-document image may, for example, refer to an image of a patch for image quality correction (correction patch image 92) for correcting a quality of an image to be printed by the image forming apparatus 200. The color material consumption amount calculating part 6 calculates information on color material consumption by multiplying the color material adhesion amount 23 (mg/sheet) by the toner transfer proportion (color material adhesion proportion 22). The information on color material consumption may include either the toner consumption amount 24 or the consumption cost, or both the toner consumption amount 24 and the consumption cost. The color material adhesion amount 23 is derived from the print coverage of the document image and the print coverage of the non-document image.

The image forming apparatus 200 is configured to form a document image and a non-document image (e.g., a correction patch image 92) on a medium using a color material (developer including dry toner). The medium may typically be a white paper, but includes a transparent medium. The image forming apparatus 200 may perform white underlayer printing on a transparent medium and perform color printing thereon. In this case, a usage amount of a white toner increases. The image forming apparatus 200 includes an image forming part 60, a controller 70, a temperature and humidity measurer 80 (shown as “temp and humidity measurer” in FIG. 1), and a storage part 90. The image forming part 60 performs printing by transferring a dry toner onto a medium and heat fixing the transferred toner onto the medium. Since the image forming part 60 includes a fixing device that heat fixes the dry toner to the medium, a toner usage amount changes with a change in temperature and/or humidity. The controller 70 is a central processing unit (CPU) and controls the image forming part 60 by executing a program. The temperature and humidity measurer 80 measures temperature and humidity inside the apparatus. The storage part 90 includes a storage area for storing print coverage 91 and a storage area for storing a correction patch image 92.

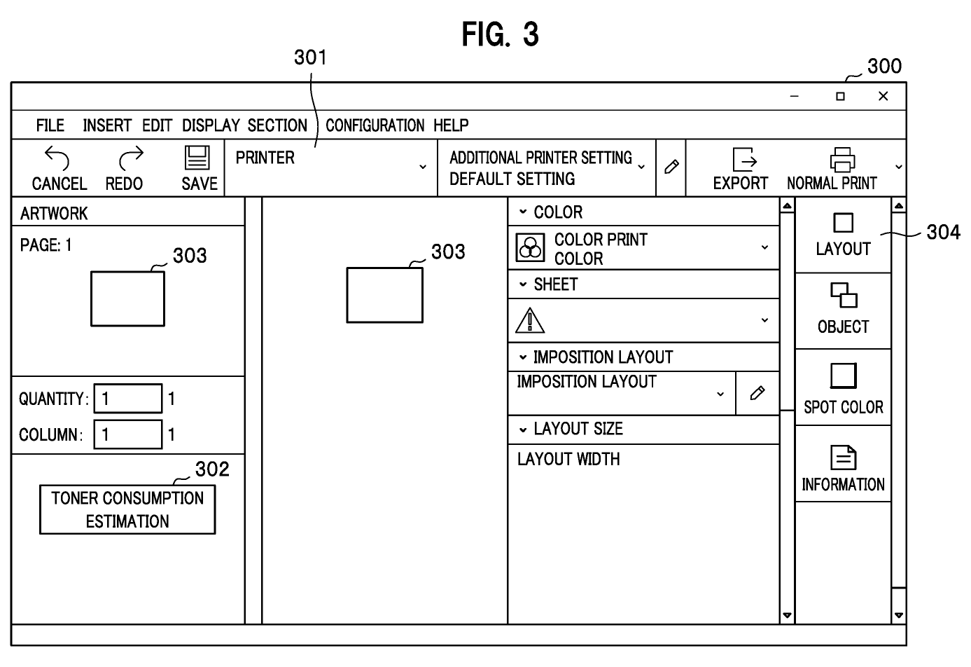

FIG. 3 is a diagram illustrating an example of a display screen that is displayed when a toner consumption estimation is to be started.

When an operator drags and drops an icon or the like indicating document data onto a screen and double-clicks the icon or the like, a toner consumption estimation start screen 300 is displayed on the display operation part 50 (FIG. 1).

The toner consumption estimation start screen 300 includes a "Printer" selection button 301, a "Toner consumption estimation" button 302, a "Layout" button 304, and the like. Furthermore, a print image 303 to be printed is displayed at two positions on the toner consumption estimation start screen 300.

When the "Printer" selection button 301 is clicked, one or more connected printers (e.g., the image forming apparatus 200 [FIG. 1]) are displayed as a drop down. When a user selects one printer to perform printing, a job and a printer become associated with each other.

Next, when the user clicks on a "Layout" button 304, a drop-down menu displays entries such as "Color", "Sheet", "Imposition layout", and "Layout work”. The user may select a menu entry and perform a setting.

Next, when the user clicks on the "Toner consumption estimation" button 302, the management program 21 (FIG. 1) is executed.

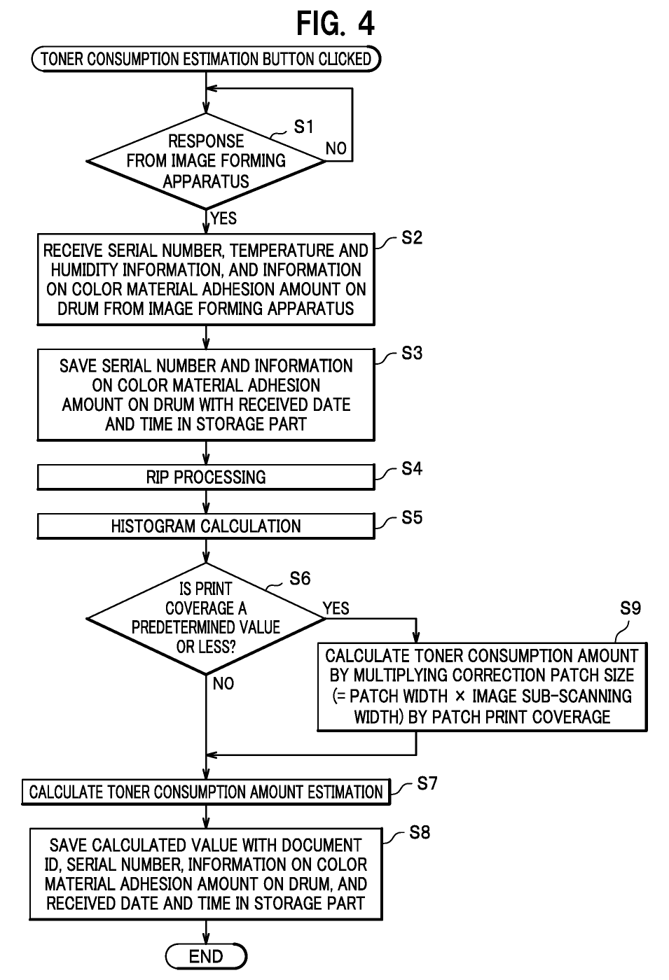

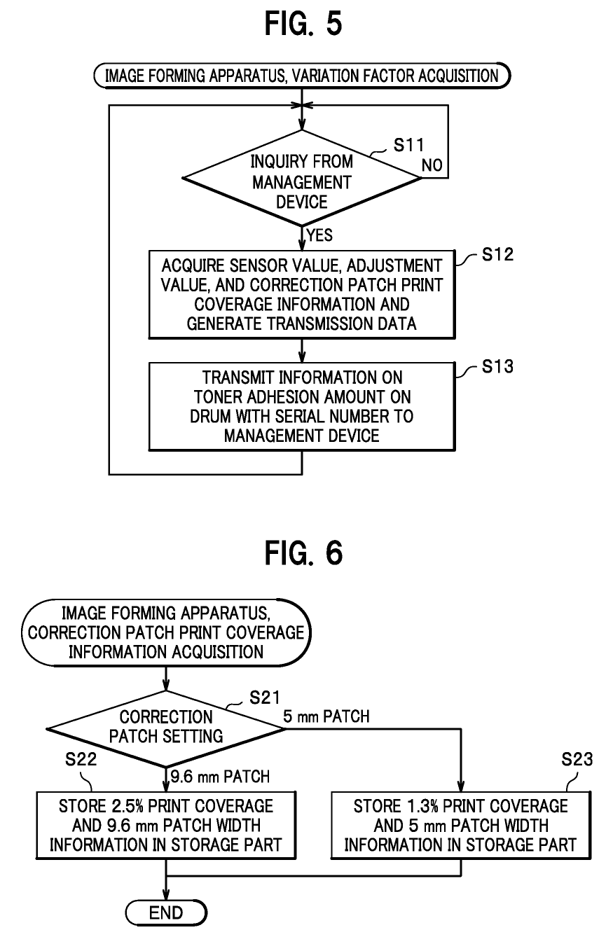

FIG. 4 is a flowchart illustrating an operation of the management device according to an embodiment of the present invention. This flow is started by clicking on the "Toner consumption estimation" button 302 (FIG. 3). Note that in the image forming apparatus 200, flows of FIGS. 5 and 6 to be described later are activated.

The controller 10 (FIG. 1) determines whether or not there is a response from the image forming apparatus 200 (step S1). If there is no response ("No" in step S1), the controller 10 waits until there is a response from the image forming apparatus 200.

FIG. 5 is a flowchart illustrating an operation of the image forming apparatus 200 when acquiring a variation factor (e.g., temperature and humidity information, an amount of color material adhered on a drum, or the like).

The controller 70 of the image forming apparatus 200 determines whether or not there is an inquiry from the management device 100 (step S11). When there is no inquiry ("No" in step S11), the controller 70 waits until there is an inquiry. When there is an inquiry ("Yes" in step S11), the controller 70 acquires a sensor value (e.g., temperature and humidity information), an adjustment value, and correction patch print coverage information, and generates transmission data (step S12). After the processing of step S12, the controller 70 transmits information on a toner adhesion amount on the drum to the management device 100 (FIG. 1) together with a serial number (step S13). After the processing of step S13, the controller 70 repeats the processing of step S11.

Returning to the description of FIG. 4, when there is a response from the image forming apparatus 200 ("Yes" in step S1), the controller 10 acquires predetermined information (step S2). The predetermined information includes the serial number, temperature and humidity information, and information on a color material adhesion amount 23 (mg/sheet) on the drum. At this time, the temperature and humidity information may be acquired not only from the image forming apparatus 200 but from a network via the communication part 40 (a temperature and humidity information acquiring step). The color material adhesion amount 23 is derived from a print coverage of a document image and a print coverage of a non-document image. After the processing of step S2, the controller 10 stores the serial number and the information on a color material adhesion amount 23 (FIG. 1) on the drum together with a reception date and time in the storage part 20 (step S3).

After the processing of step S3, the RIP part 1 of the controller 10 performs RIP processing on the print data (step S4). After step S4, the histogram extraction part 2 calculates a histogram (step S5). After the processing of step S5, the controller 10 determines whether or not a print coverage is equal to or less than a predetermined value (e.g., 3%) (step S6). A print coverage of the document image is obtained from a processing result obtained by performing RIP processing on the print data. A print coverage of the non-document image (a correction patch) is acquired from the image forming apparatus 200 (print coverage acquiring step). At this time, the flow of FIG. 6 is being executed by the image forming apparatus 200.

FIG. 6 is a flowchart illustrating an operation when the image forming apparatus acquires print coverage information of the correction patch.

The controller 70 (FIG. 1) of the image forming apparatus 200 determines whether the correction patch is set to a 5 mm patch or 9.6 mm patch (step S21). When the correction patch is set to the 9.6 mm patch (9.6 mm patch), the controller 70 stores a value of 2.5% as print coverage in a storage area of the storage part 90 for storing print coverage 91 and stores information on the 9.6 mm patch in a part of a storage area of the storage part 90 for storing the correction patch image 92 (step S22), and the processing ends.

When the correction patch is set to the 5 mm patch (5 mm patch), the controller 70 stores a value of 1.3% as print coverage in a storage area of the storage part 90 for storing the print coverage 91 and stores information on the 5 mm patch in a part of a storage area of the storage part 90 for storing the correction patch image 92 (step S23), and the processing ends.

Returning to the description of FIG. 4, when the print coverage exceeds the predetermined value (“No” in step S6), the color material consumption amount calculating part 6 of the controller 10 performs estimation calculation of the toner consumption amount 24 (FIG. 1) or consumption cost (step S7, color material consumption amount calculating step). The toner consumption amount 24 is calculated by multiplying the color material adhesion amount 23 acquired in step S2 by the toner transfer proportion (color material adhesion proportion 22). At this time, the controller 10 acquires the color material adhesion proportion 22 from the storage part 20 (color material adhesion proportion information acquiring step). After the processing of step S7, the controller 10 stores the calculated value (toner consumption amount 24) calculated in step S7 in the storage part 20 together with a document ID, the serial number of the image forming apparatus 200, the color material adhesion amount 23 on the drum, and the reception date and time (step S8), and the process ends.

On the other hand, when the print coverage is less than or equal to the predetermined value (“Yes” in step S6), the controller 10 multiplies a correction patch size by the patch print coverage to calculate the toner consumption amount (step S9). Here, the correction patch size is equal to a patch width multiplied by an image sub-scanning width (correction patch size = patch width × image sub-scanning width). The patch width is a width in a direction perpendicular to a medium feeding direction. The image sub-scanning width is a width in the medium feeding direction. After the processing of step S9, the controller 10 executes the processing of step S7 and step S8, and the processing ends.

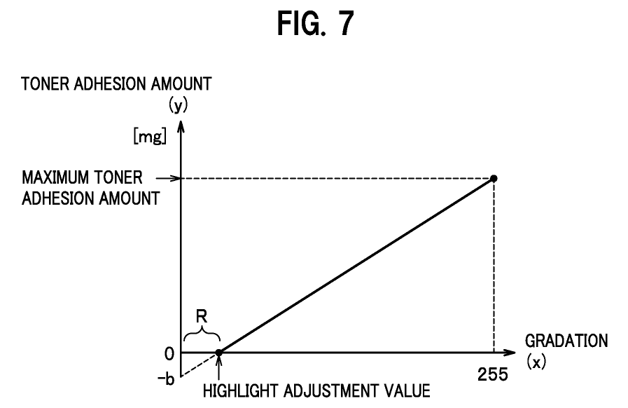

FIG. 7 is a diagram illustrating a relationship of a toner adhesion amount on a drum to a gradation.

The horizontal axis represents a gradation x (0 to 255). The vertical axis represents a toner adhesion amount y [mg] on the drum.

The toner adhesion amount is expressed by a straight line passing through an intercept -b. That is, when a is a slope, the toner adhesion amount y is expressed by y = ax-b. A point at which this straight line intersects the horizontal axis (axis of the gradation x) is referred to as a highlight adjustment value (e.g., the highlight adjustment value may be up to a gradation x of approximately 10). A region R between gradation 0 and the highlight adjustment value is a highlight portion (a portion that looks bright or a white portion).

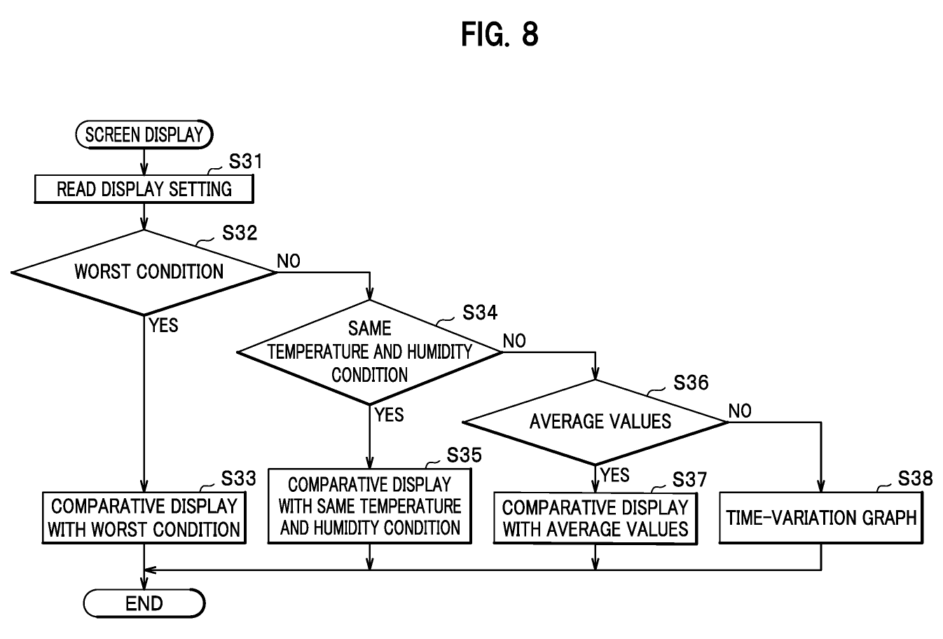

FIG. 8 is a flowchart for explaining an operation when the management device displays a screen of the toner consumption amount. This flow is started when the processing of FIG. 4 ends and a toner consumption amount display button (not illustrated) is clicked. Note that a display setting is set in the storage part 20 (FIG. 1) in advance by a user. The display setting may be set to a worst condition, the same temperature and humidity condition, or average values.

The controller 10 of the management device 100 reads the display setting (step S31). After the processing of step S31, the controller 10 determines whether the display setting is set to a "worst condition" (step S32). In a case of the "worst condition" (“Yes" in step S32), a display control part (not illustrated) of the controller 10 causes the display operation part 50 (FIG. 1) to display a comparative display in which the toner consumption amount calculated in step S7 (FIG. 4) is compared with a toner consumption amount for the "worst condition" (step S33), and the process is ends.

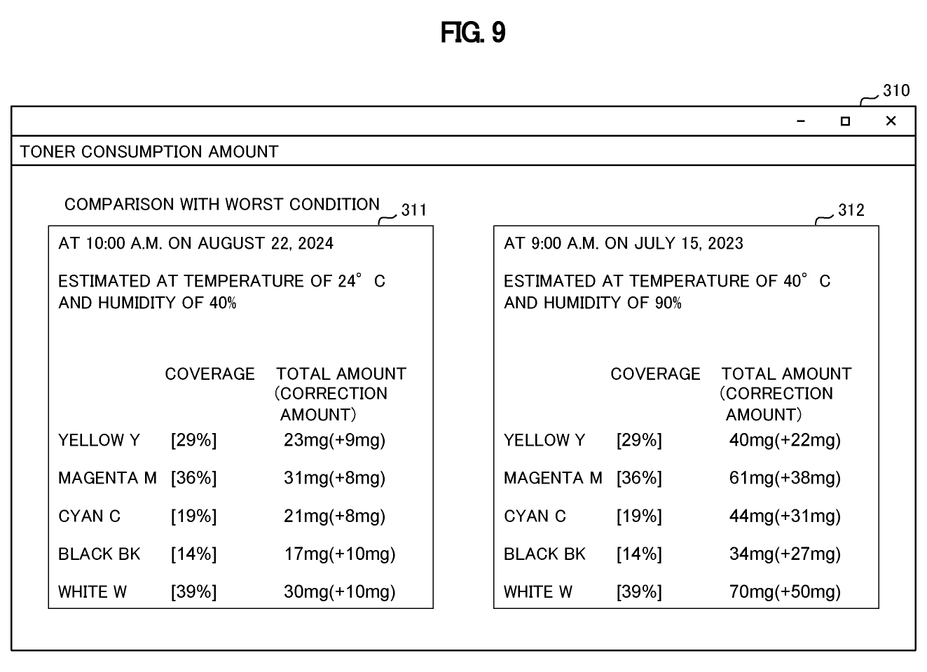

FIG. 9 is a diagram illustrating an example of a display screen when the estimated toner consumption amount is compared with the toner consumption amount under the worst condition.

The estimated toner consumption amount display screen 310 is configured to include an estimated toner consumption amount display area 311 and a worst condition toner consumption amount display area 312, which are arranged next to each other. The estimated toner consumption amount display area 311 displays, for example, a date and time “At 10:00 a.m. on August 22, 2024" and character strings “Estimated at temperature of 24°C and humidity of 40%". Further, the estimated toner consumption amount display area 311 displays color names (yellow Y, magenta M, cyan C, black BK, and white W) and, for each color, calculated values of "coverage" and “total [toner] amount (correction amount)". Here, the coverage is a proportion of a print region calculated from a toner consumption amount that is actually used when a toner consumption amount for printing an entire printable range of one page with one color is set to 100%.

For example, for yellow Y, when the coverage is 29%, the estimated total amount is 23 mg, of which the correction amount is +9mg. For example, for magenta M, when the coverage is 36%, the estimated total amount is 31 mg, of which the correction amount is +8 mg. For example, for cyan C, when the coverage is 19%, the estimated total amount is 21 mg, of which the correction amount is +8mg. For example, for black BK, when the coverage is 14%, the estimated total amount is 17 mg, of which the correction amount is +10mg. For example, for white W, when the coverage is 39%, the estimated total amount is 30 mg, of which the correction amount is +10 mg.

The worst condition toner consumption amount display area 312 displays, for example, a date and time “At 9:00 a.m. on July 15, 2024", temperature and humidity “Estimated at temperature of 40°C and humidity of 90%”, and "Coverage” and calculated values of "Total [toner] amount (correction amount)" for each color.

Under the worst condition of "temperature of 40°C and humidity of 90%", for example, a total amount of toner for each color increases as follows: for yellow Y, the total amount increases to 40 mg (of which the correction amount is +22 mg); for magenta M, the total amount increases to 61 mg (of which the correction amount is +38 mg); for cyan C, the total amount increases to 44 mg (of which the correction amount is +31 mg); for black BK, the total amount increases to 34 mg (of which the correction amount is +27 mg); and for white W, the total amount increases to 70 mg (of which the correction amount is +50 mg).

Returning to the flowchart of FIG. 8, when the setting is not set to the worst condition (“No” in step S32), the controller 10 determines whether temperature and humidity are at the same condition (step S34). When the temperature and humidity condition is the same (“Yes” in step S34), the display control part (not illustrated) of the controller 10 causes the display operation part 50 (FIG. 1) to display a comparative display in which the toner consumption amount calculated in step S7 (FIG. 4) is compared with a toner consumption amount under the “same temperature and humidity condition" (step S35), and the process ends.

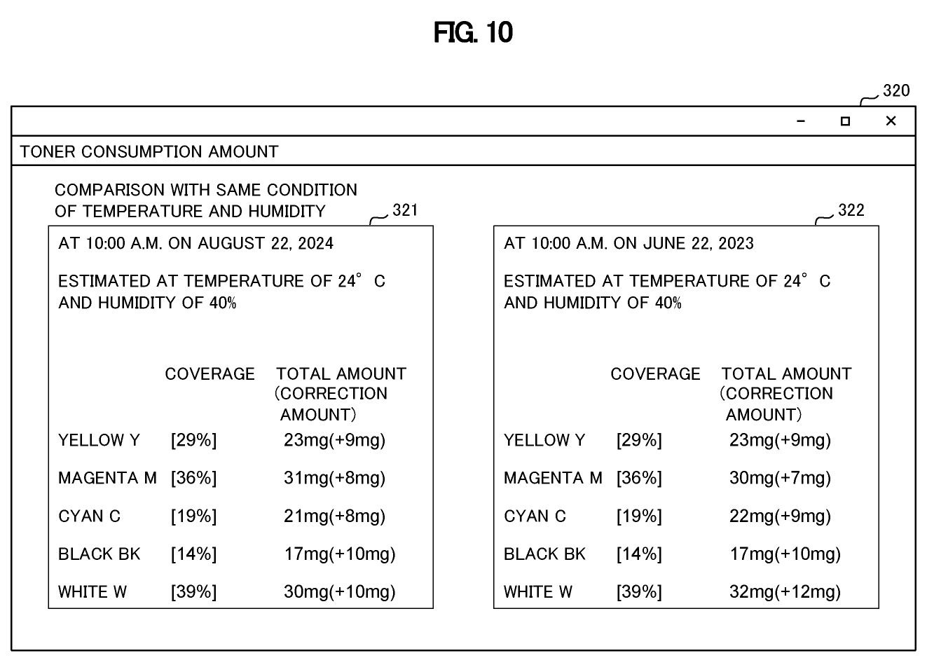

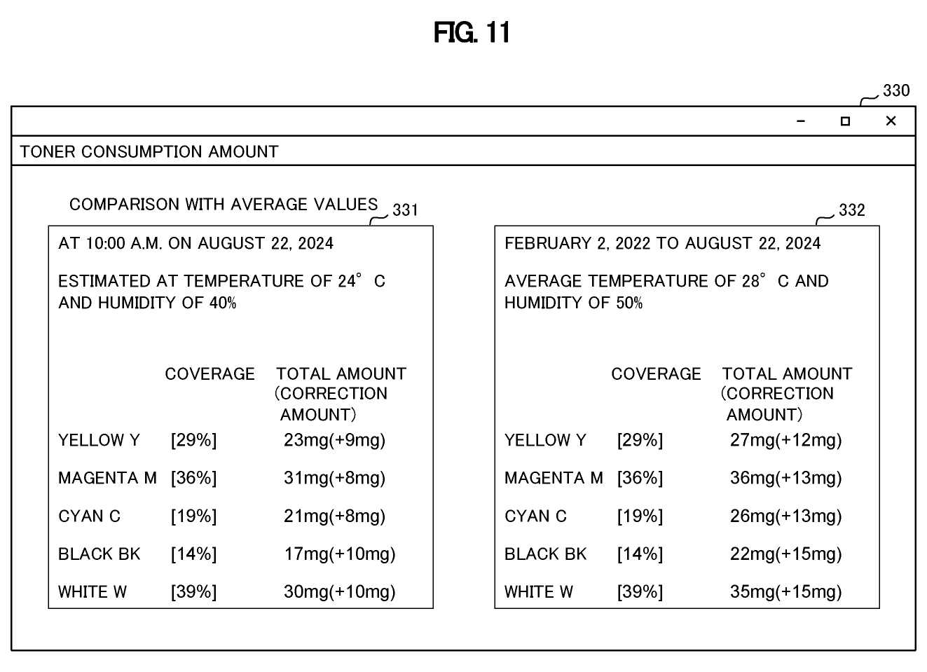

FIG. 10 is a diagram illustrating an example of a display screen when the estimated toner consumption amount is compared with that under the same condition of temperature and humidity.

The estimated toner consumption amount display screen 320 is configured to include an estimated toner consumption amount display area 321 and a same condition toner consumption amount display area 322, which are arranged next to each other on the left and right. The estimated toner consumption amount display area 321 is the same image as the estimated toner consumption amount display area 311 (FIG. 9).

The same condition toner consumption amount display area 322 displays calculated values of “Total [toner] amount (correction amount)" corresponding to the "Coverage" of each color and the same condition of temperature and humidity “Estimated at temperature of 24°C and humidity of 40%" at a date and time of “At 10:00 a.m. on June 22, 2023".

For example, for yellow Y, the total amount is 23 mg (of which the correction amount is +9 mg) and, for magenta M, the total amount is 30 mg (of which the correction amount is +7 mg). For example, for cyan C, the total amount is 22 mg (of which the correction amount is +9 mg) and, for black BK, the total amount is 17 mg (of which the correction amount is +10 mg). For example, for white W, the total amount is 32 mg (of which the correction amount +12 mg). That is, magenta M and cyan C show amounts of variation of 1 mg and white W shows an amount of variation of 2 mg.

Returning to the description of the flowchart of FIG. 8, when the setting is not set to the same temperature and humidity condition (“No” in step S34), the controller 10 determines whether or not the setting is set to average values (step S36). When the setting is set to the average values (“Yes” in step S36), the display control part (not illustrated) of the controller 10 causes the display operation part 50 (FIG. 1) to display a comparative display comparing the toner consumption amount calculated in step S7 (FIG. 4) with a toner consumption amount of “average values" (step S37), and the processing ends.

FIG. 11 is a diagram illustrating an example of a display screen when the estimated toner consumption amount is compared with average values.

The estimated toner consumption amount display screen 330 is configured to include an estimated toner consumption amount display area 331 and an average value toner consumption amount display area 332, which are arranged next to each other. Similarly to the estimated toner consumption amount display area 311 (FIG. 8), the estimated toner consumption amount display area 331 displays the date and time “At 10:00 a.m. on August 22, 2024", the temperature and humidity “Estimated at temperature of 24°C and humidity of 40%", and a calculated value of the "Total [toner] amount (correction amount)" corresponding to a "Coverage" of each color.

The average value toner consumption amount display area 332 displays a calculated value of the "total [toner] amount (correction amount)" that corresponds to the "coverage" of each color and is estimated at an average temperature and humidity “At temperature of 28 °C and humidity of 50%" over a period of approximately one year and six months between "February 2, 2022, to August 22, 2024".

For example, for yellow Y, the total amount is 27 mg (of which the correction amount is +12 mg) and, for magenta M, the total amount is 36 mg (of which the correction amount is +13 mg). For example, for cyan C, the total amount is 26 mg (of which the correction amount is +13 mg) and, for black BK, the total amount is 22 mg (of which the correction amount is +15 mg). For example, for white W, the total amount is 35 mg (of which the correction amount is +15 mg).

Returning to the description of the flowchart of FIG. 8, when the setting is not set to the average values (“No” in step S36), the display control part (not illustrated) of the controller 10 causes the display operation part 50 (FIG. 1) to display a time-variation graph of the toner consumption amount calculated in step S7 (FIG. 4) (step S38), and the processing ends.

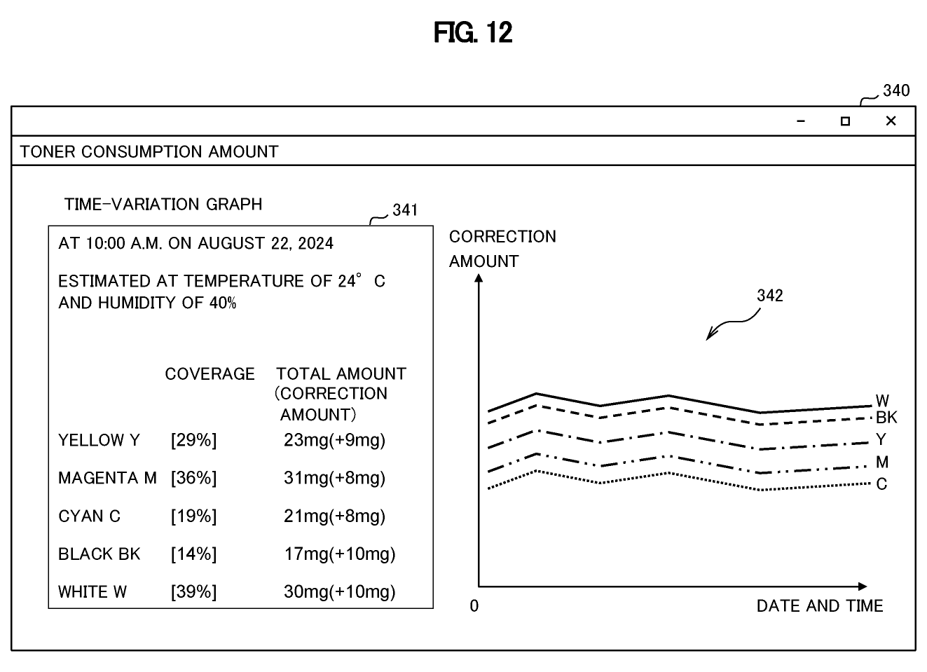

FIG. 12 is a diagram illustrating an example of a time-variation graph display screen indicating a variation in toner consumption amount.

The time-variation graph display screen 340 is configured to include an estimated toner consumption amount display area 341 and a time-variation graph 342, which are arranged next to each other. Similarly to the estimated toner consumption amount display area 311 (FIG. 9), the estimated toner consumption amount display area 341 displays a character string “At 10:00 a.m. on August 22, 2024" indicating the date and time, a character string “Estimated at temperature of 24°C and humidity of 40%" indicating the temperature and humidity for estimation, and the calculated values of “Total [toner] amount (correction amount)" corresponding to the "Coverage" of each color.

In the time-variation graph 342, the horizontal axis represents a date and time and the vertical axis represents a correction amount. The time-variation graph 342 is a graph in which information on color material consumption calculated in the past is plotted in a time series. Note that the time of installation of the apparatus is at t = 0. A time-variation graph 342 indicates a temporal change in the correction amount for each of the toner colors of yellow Y, magenta M, cyan C, black BK, and white W.

### Advantageous Effect

According to the embodiment, it is possible to more accurately estimate in advance a usage amount of a color material to be used by an image forming apparatus.

### Comparative Example

In the embodiment, the toner usage amount is estimated by taking into consideration the temperature and humidity information with the print data. However, the toner usage amount may be estimated with only the print data (image data).

When the toner usage amount is estimated with only the image data, a maximum error of 22% may occur in the maximum toner adhesion amount, an error of 11% may occur in an exterior temperature and humidity, and a maximum error of 15% may occur in a take-off bar / real-time color correction patch. In total, an error of up to 46.9% may occur.

Here, when the technology of Patent Literature 1 (Japanese Patent Number 6823962) is applied, the maximum error of 22% of the maximum toner adhesion amount may be reduced. Further, according to the technology of the embodiment, the error of 11% of the exterior temperature and humidity may be reduced and the maximum error of 15% of the take-off bar / real-time color correction patch may be reduced.

That is, the amount of toner consumption amount may be obtained with high accuracy. Therefore, an appropriate estimate may be made at the time of a business negotiation regarding the toner. As a result, it is less likely for an estimate to be issued that leads to loss due to underestimating the cost or for an estimate to be issued that leads to losing an order due to overquoted fee.

### Modification Examples

The present invention is not limited to the above-described embodiments and may be modified without departing from the spirit and scope of the present invention. For example, modifications such as (a) to (c) are possible.

(a) In the management device 100 of the embodiment, the controller 10 acquires the temperature and humidity information and the information on the color material adhesion amount 23 (FIG. 1) on the drum from the image forming apparatus 200 (step S2). The color material adhesion amount 23 is derived from a print coverage of the document image and a print coverage of the non-document image. Therefore, the management device 100 may acquire the print coverage from the image forming apparatus 200 and the controller 10 may calculate the color material adhesion amount 23.

(b) The management device 100 of the above-described embodiment acquires the temperature and humidity information from the image forming apparatus 200 or the temperature and humidity measurer 120 (FIG. 1) (step S2). Further, the management device 100 uses the table of the toner transfer proportion (the color material adhesion proportion 22 [FIGS. 1, 2]) stored in the storage part 20 (step S7). In one or more embodiments, the management device 100 may acquire the toner transfer proportion (color material adhesion proportion 22) corresponding to the temperature and humidity measured by the temperature and humidity measurer 80 (FIG. 1) from the image forming apparatus 200. The controller 10 may multiply the color material adhesion amount 23 acquired in step S2 by the toner transfer proportion (color material adhesion proportion 22) corresponding to the temperature and humidity information. In this way, the toner consumption amount 24 may be calculated.

(c) The management device 100 according to the embodiment is connected to the image forming apparatus 200. The management device 100 may further be connected to a digital front end (DFE) that incorporates an International Color Consortium (ICC) profile or to a management information system (MIS).

### Aspects

A first aspect of the disclosure provides a management device that includes an interface, a print coverage acquiring part, a temperature and humidity information acquiring part, a color material adhesion proportion information acquiring part, and a color material consumption amount calculating part. The interface is configured to connect with an image forming apparatus that forms a document image and a non-document image (e.g., an image of a correction patch) on a medium. The print coverage acquiring part is configured to acquire a print coverage of the non-document image from the image forming apparatus. The temperature and humidity information acquiring part is configured to acquire temperature and humidity information of the image forming apparatus. The color material adhesion proportion information acquiring part is configured to acquire a color material adhesion proportion (e.g., toner transfer proportion) that is a function of the temperature and humidity information. The color material consumption amount calculating part is configured to calculate information on color material consumption (e.g., toner consumption amount) by multiplying a color material adhesion amount by the color material adhesion proportion. The color material adhesion amount is derived from a print coverage of the document image and the print coverage of the non-document image.

A second aspect of the disclosure provides a management device that is in accordance with the first aspect and in which the color material adhesion proportion is a toner transfer proportion, the non-document image is an image of a correction patch used to correct an image quality, and the information on color material consumption includes either a toner consumption amount or a consumption cost or both the toner consumption amount and the consumption cost.

A third aspect of the disclosure provides a management device that is in accordance with the first aspect and in which the temperature and humidity information acquiring part is configured to calculate an average value of the temperature and humidity information obtained by averaging the temperature and humidity information for a set period.

A fourth aspect of the disclosure provides a management device that is in accordance with the first aspect and in which the temperature and humidity information acquiring part is configured to acquire information on temperature and humidity of the image forming apparatus.

A fifth aspect of the disclosure provides a management device that is in accordance with the first aspect and in which the temperature and humidity information acquiring part is configured to acquire, via a network, information on ambient temperature and humidity.

A sixth aspect of the disclosure provides a management device that is in accordance with a first aspect and further includes a display control part. The display control part is configured to display on a display a comparative display of the following: the information on color material consumption calculated by the color material consumption amount calculating part; and the information on color material consumption under a worst-case condition of temperature and humidity of the image forming apparatus, under the same condition of the temperature and humidity, or when the temperature and humidity are at average values.

A seventh aspect of the disclosure provides a management device that is in accordance with a first aspect and further includes a display control part. The display control part is configured to display on a display a graph in which the information on color material consumption calculated in the past by the color material consumption amount calculating part is plotted in chronological order.

An eighth aspect of the disclosure provides a management system that includes the following: an image forming apparatus configured to form a document image and a non-document image on a medium; and a management device configured to manage the image forming apparatus. The management device includes a print coverage acquiring part, a temperature and humidity information acquiring part, a color material adhesion proportion information acquiring part, and a color material consumption amount calculating part. The print coverage acquiring part is configured to acquire a print coverage of the non-document image from the image forming apparatus. The temperature and humidity information acquiring part is configured to acquire temperature and humidity information of the image forming apparatus. The color material adhesion proportion information acquiring part is configured to acquire a color material adhesion proportion that is a function of the temperature and humidity information. The color material consumption amount calculating part is configured to calculate information on color material consumption by multiplying a color material adhesion amount by the color material adhesion proportion. The color material adhesion amount is derived from a print coverage of the document image and the print coverage of the non-document image.

A ninth aspect of the disclosure provides a management method for a management device that connects to an image forming apparatus that forms a document image and a non-document image on a medium. The management method includes acquiring a print coverage of the non-document image from the image forming apparatus, acquiring temperature and humidity information of the image forming apparatus, acquiring a color material adhesion proportion that is a function of the temperature and humidity information, and calculating information on color material consumption by multiplying a color material adhesion amount by the color material adhesion proportion. The color material adhesion amount is derived from a print coverage of the document image and the print coverage of the non-document image.

A tenth aspect of the disclosure provides a non-transitory storage medium storing a management program for a computer that connects to an image forming apparatus that forms a document image and a non-document image on a medium. The management program causes the computer to acquire a print coverage of the non-document image from the image forming apparatus, acquire temperature and humidity information of the image forming apparatus, acquire a color material adhesion proportion that is a function of the temperature and humidity information, and calculate information on color material consumption by multiplying a color material adhesion amount by the color material adhesion proportion. The color material adhesion amount is derived from a print coverage of the document image and the print coverage of the non-document image.

Although an embodiment of the present invention has been described and illustrated in detail, the disclosed embodiment is made for purposes of illustration and example only and not limitation. The scope of the present invention should be interpreted by terms of the appended claims.

What is claimed is:

1. A management device, comprising:
an interface configured to connect with an image forming apparatus that forms a document image and a non-document image on a medium; and
a hardware processor, wherein
the hardware processor is configured to:
acquire, as a print coverage acquiring part, a print coverage of the non-document image from the image forming apparatus;
acquire, as a temperature and humidity information acquiring part, temperature and humidity information of the image forming apparatus;
acquire, as a color material adhesion proportion information acquiring part, a color material adhesion proportion that is a function of the temperature and humidity information; and
calculate, as a color material consumption amount calculating part, information on color material consumption by multiplying a color material adhesion amount by the color material adhesion proportion, the color material adhesion amount being derived from a print coverage of the document image and the print coverage of the non-document image.

2. The management device according to claim 1, wherein
the color material adhesion proportion is a toner transfer proportion;
the non-document image is an image of a correction patch used to correct an image quality; and
the information on color material consumption includes either a toner consumption amount or a consumption cost or both the toner consumption amount and the consumption cost.

3. The management device according to claim 1, wherein
the hardware processor is configured to calculate, as the temperature and humidity information acquiring part, an average value of the temperature and humidity information obtained by averaging the temperature and humidity information for a set period.

4. The management device according to claim 1, wherein
the hardware processor is configured to acquire, as the temperature and humidity information acquiring part, information on temperature and humidity of the image forming apparatus.

5. The management device according to claim 1, wherein
the hardware processor is configured to acquire, as the temperature and humidity information acquiring part, information on ambient temperature and humidity via a network.

6. The management device according to claim 1, wherein
the hardware processor is configured to display on a display a comparative display of:
the information on color material consumption calculated by the color material consumption amount calculating part; and
the information on color material consumption under a worst-case condition of temperature and humidity of the image forming apparatus, under the same condition of the temperature and humidity, or when the temperature and humidity are at average values.

7. The management device according to claim 1, wherein
the hardware processor is configured to display on a display a graph in which the information on color material consumption calculated in the past by the color material consumption amount calculating part is plotted in chronological order.

8. A management system, comprising:
an image forming apparatus configured to form a document image and a non-document image on a medium; and
a management device configured to manage the image forming apparatus, wherein
the management device includes a hardware processor configured to:
acquire a print coverage of the non-document image from the image forming apparatus;
acquire temperature and humidity information of the image forming apparatus;
acquire a color material adhesion proportion that is a function of the temperature and humidity information; and
calculate information on color material consumption by multiplying a color material adhesion amount by the color material adhesion proportion, the color material adhesion amount being derived from a print coverage of the document image and the print coverage of the non-document image.

9. A non-transitory storage medium storing a management program for a computer that connects to an image forming apparatus that forms a document image and a non-document image on a medium, the management program causing the computer to:
acquire a print coverage of the non-document image from the image forming apparatus;
acquire temperature and humidity information of the image forming apparatus;
acquire a color material adhesion proportion that is a function of the temperature and humidity information; and
calculate information on color material consumption by multiplying a color material adhesion amount by the color material adhesion proportion, the color material adhesion amount being derived from a print coverage of the document image and the print coverage of the non-document image.
